(19) United States
(12) Patent Application Publication
(10) Pub. No.: US 2022/0358451 A1
(43) Pub. Date: Nov. 10, 2022

(54) AUTOMATED INVENTORY MANAGEMENT METHOD AND SYSTEM THEREOF

(71) Applicant: INDUSTRIAL TECHNOLOGY RESEARCH INSTITUTE, Hsinchu (TW)

(72) Inventors: Sian-Hong HUANG, Kaohsiung City (TW); En-Tzu WANG, Kaohsiung City (TW); Chi-Yuan YEH, Hsinchu City (TW); Min-Yen WU, Taichung City (TW)

(73) Assignee: INDUSTRIAL TECHNOLOGY RESEARCH INSTITUTE, Hsinchu (TW)

(21) Appl. No.: 17/369,477

(22) Filed: Jul. 7, 2021

(30) Foreign Application Priority Data
Apr. 21, 2021 (TW) 110114402

(51) Int. Cl. G06Q 10/08; G06N 20/00

(52) U.S. Cl. CPC G06Q 10/087; G06N 20/00

(57) ABSTRACT

An automated inventory management method is provided. A historical sale record is received, and a future sale of an item is predicted based on the historical sale record to obtain a simulation result of an expected sale state of the item in the next sale cycle. According to the historical sale record of full categories of items and the simulation result of the item in the next sale cycle, an initial weight of the pre-training model is trained and used as a weight of an inventory decision module, and a purchase order that meets the expected sale record of the item in the next sale cycle is automatically generated. A reward feedback is calculated according to a current sale record and an inventory volume of the item and a purchase order of the previous sale cycle and input into the inventory decision module to order the item.

This application claims the benefit of Taiwan application Serial No. 110114402, filed Apr. 21, 2021, the disclosure of which is incorporated by reference herein in its entirety.

### BACKGROUND

### Technical Field

The disclosure relates in general to a management method, and applies to an automated inventory management method and a system thereof.

### Description of the Related Art

In a modern society, competition in various industries is becoming increasingly fierce, and how to effectively reduce inventory costs has been concerned by everyone. Regarding inventory decisions, most of them use Demand Driven Material Requirements Planning (DDMRP) as the basis for the purchase order, and adjust the purchase order based on historical average sale record, historical sale standard deviation, order delivery time, and demand variation parameters. The demand variation parameters must be manually set, which relies on the experience of the personnel. Therefore, the uncertain factors of order increase in the future, and it is very likely that the inventory costs will increase or out of stock because of few inventory.

### SUMMARY

The disclosure is directed to an automated inventory management method and a system thereof, which could replace personnel to manually set parameters, and reduce inventory costs and the risk of personnel misjudgment.

According to one embodiment of the disclosure, an automated inventory management method is provided, which includes the following steps. A historical sale state is received, and a future sale of an item is predicted based on the historical sale state to obtain a simulation result of an expected sale state of the item in the next sale cycle. According to the historical sale state of full categories of items and the simulation result of the expected sale state of the item in the next sale cycle, an initial weight of a pre-training model is trained. The initial weight of the pre-training model is used as a weight of an inventory decision module for training, and a purchase order that meets the expected sale state of the item in the next sale cycle is automatically generated. A reward feedback is calculated according to a current sale record and an inventory volume of the item and a purchase order of the item in a previous sale cycle, and the reward feedback and the sale state of the item are input into the inventory decision module to order the item.

According to one embodiment of the disclosure, an automated inventory management system is provided, which includes a historical parameter analysis module, a state analysis module, an initial weight setting module, and an inventory decision module. The historical parameter analysis module is used to receive a historical sale state, and predict a future sale of an item based on the historical sale state, so as to obtain a simulation result of an expected sale state of the item in a next sale cycle. The initial weight setting module is used for training an initial weight of a pre-training model based on the historical sale state of full categories of items and the simulation result of the expected sale state of the item in the next sale cycle. The inventory decision module uses the initial weight of the pre-training model as a weight of the inventory decision module for training, and automatically generates a purchase order that meets the expected sale state of the item in the next sale cycle. The state analysis module calculates a reward feedback based on a current sale record and an inventory volume of the item and a purchase order in a previous sale cycle, and inputs the reward feedback and the sale state of the item into the inventory decision module to order the item.

### BRIEF DESCRIPTION OF THE DRAWINGS

FIG. 1 is a schematic diagram of an automated inventory management system according to an embodiment of the disclosure;

FIG. 2 is a flowchart of an automated inventory management method according to an embodiment of the disclosure;

FIG. 3 is a schematic diagram of an automated inventory management interface according to an embodiment of the disclosure;

FIG. 4 is a schematic diagram of the purchase analysis of products of different items.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Exemplary embodiments will now be described more fully with reference to the accompanying drawings. However, the exemplary embodiments could be implemented in various forms, and should not be construed as being limited to the examples set forth herein; on the contrary, the description of these embodiments makes the present disclosure more comprehensive and complete, and fully conveys the concept of the exemplary embodiments to those skilled in the art. The described features, structures or characteristics could be combined in one or more embodiments in any suitable way.

In addition, the drawings are schematic illustrations of the present disclosure, and are not necessarily drawn to scale. The same reference numerals in the drawings denote the same or similar parts, and thus their repeated description will be omitted. Some of the block diagrams shown in the drawings are functional entities and do not necessarily correspond to physically or logically independent entities. These functional entities could be implemented in the form of software, or implemented in one or more hardware modules or integrated circuits, or implemented in different networks and/or processor devices and/or microcontroller devices. For example: the historical parameter analysis module, the state analysis module, the initial weight setting module, the pre-training model, the inventory decision module, and the transfer model described therein could be implemented in the form of software to realize these functional entities, or implemented in one or more hardware modules or integrated circuits.

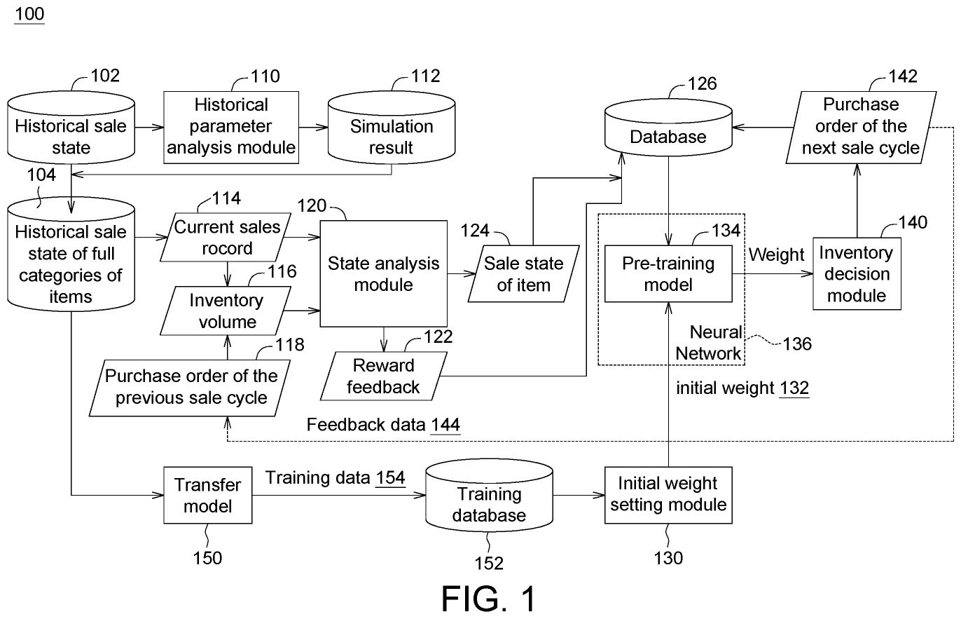

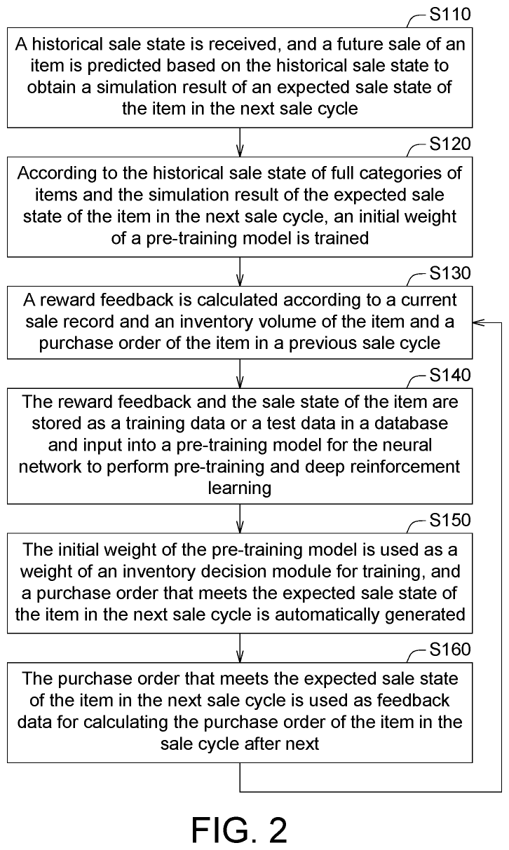

Please refer to FIGS. 1 and 2. FIG. 1 shows a schematic diagram of an automated inventory management system 100 according to an embodiment of the disclosure, and FIG. 2 shows a flowchart of an automated inventory management method according to an embodiment of the disclosure.

As shown in FIG. 1, the automated inventory management system 100 may include a historical parameter analysis module 110, a state analysis module 120, a database 126, an initial weight setting module 130, and a pre-training model 134, an inventory decision module 140, a transfer model 150, and a training database 152. The historical parameter analysis module 110 could predict the future sale record based on the historical sale state 102, the average sale record and the standard deviation of the sale items. The historical sale state 102 is, for example, the historical sale record of the item in the 52 weeks before the time point t. The average sale record is, for example, the historical average sale record of the item in the 13 weeks before the time point t. The standard deviation is, for example, the historical standard deviation of the sale record of the item in the 13 weeks before the time point t. Prediction of future sale record is, for example, a rough estimation of the expected sale record of the item in the next sale cycle t+1. For example, if the prediction of future sale record is greater than the historical average sale record of 13 weeks, the inventory level is increased. Meanwhile, the supplier may estimate a higher demand for sale record, and the retailer may also increase the sale prediction to avoid shortage of the inventory (i.e., out of stock); if the prediction of future sale record is less than the historical average sale record of 13 weeks, the inventory level is lowered. Meanwhile, the supplier may estimate a lower demand for sale record, and the retailer may also reduce the sale prediction to avoid full inventory.

However, the historical parameter analysis module 110 predicts the future sale record based on the historical sale state 102, the average sale record and its standard deviation of items of same category. When the predicted variation is greater than the safety level (such as the standard deviation of the sale record), it may still happen that the retailer may increase the purchase order and increases the risk cost of full inventory, or the retailer may reduce the purchase order and increases the risk cost of shortage (i.e., out of stock) due to the uncertainty of the simulation prediction. This phenomenon is also called forecast inflation. In order to prevent the above situation, the automated inventory management system 100 of present embodiment calculates a reward feedback 122 based on the current sale record 114, an inventory volume 116 and the purchase order 118 of the item in the previous sale cycle through the state analysis module 120 and the reward feedback is input into a pre-training model 134 to predict the sale record of the next sale cycle, so as to avoid relying on the past experience and self-judgment of the personnel to determine the required sale record.

Especially in the new product launch stage, there is no reliable and clear historical sale state 102 to predict future sale, and there is no enough actual sale as training data to help the neural network 136 perform deep reinforcement learning, so that the weight of each parameter in the neural network 136 that affects the sale record could not be modified and could not improve the accuracy of the sale record prediction. In order to improve the learning efficiency and prediction accuracy of the neural network 136, the automated inventory management system 100 of present embodiment further converts the historical sale state 104 of full categories of items into training data 154 through a transfer model 150, and stores the training data in the training database 152 to increase the data of the pre-trained model 134, and then the initial weight 132 of each parameter of the neural network 136 could be set through the initial weight setting module 130, that is, the initial weight 132 of the pre-trained model 134. The neural network 136 could start training on the basis of a pre-trained model 134. Compared with the conventional neural network that needs to be trained from the beginning, the neural network 136 in present embodiment does not need to adjust weights of the parameters by trial and error. The training time could be saved, and the convergence speed is relatively faster.

Referring to FIGS. 1 and 2, the automated inventory management method includes the following steps. In step S110, the historical parameter analysis module 110 receives a historical sale state 102, and predicts the future sale of an item based on the historical sale state 102 to obtain a simulation result 112 of an expected sale state of the item in a next sale cycle.

In step S120, the transfer model 150 could train a pre-training model 134 based on the historical sale states 104 of full categories of items and the simulation result 112 of the expected sale state of each item in the next sale cycle. The historical sale states 104 of full categories of the items include each of the historical sale states of items of different types in same attribute. For example, an item to be sold is a certain category of soda, cola, sprite, or juice, while the full categories of items (such as beverages) includes different types of items such as soda, cola, sprite, and juice from the same brand or other brands. That is, the transfer model 150 could convert the historical sale state 102 and the simulation result 112 of each item of different types in same attribute into training data, and store the training data 154 in the training database 152 to increase data of pre-training model 134.

In the embodiment, the historical sale states 104 of different types of beverages such as sodas, cola, and juices of the same brand or other brands are used as the training data for a new product in launch stage to establish an initial weight 132 of a pre-training model 134 and could reduce the prediction error (that is, the reward feedback 122), and could also reduce the probability of full inventory or out of stock, and thus reduce inventory costs.

In step S130, the state analysis module 120 calculates a reward feedback 122 based on the current sale record 114 and inventory volume 116 of the item and the purchase order 118 of the item in the previous sale cycle. Then, in step S140, the reward feedback 122 and the sale state 124 of the item are stored as a training data or a test data in a database 126 and input into a pre-training model 134 for the neural network 136 to perform pre-training and deep reinforcement learning. At the same time, after the training of the neural network 136 is completed, the reward feedback 122 and the sale state 124 of the item could be directly input to the inventory decision module 140 to order the item. After a predetermined period, if necessary, re-evaluation and re-training is required for adjustment. In the embodiment, the training data is used to construct the parameters and neural network 136 that are optimized for the automated inventory management system 100, and the test data could be used as input data for testing the neural network 136 constructed from the training data to ensure that such output of the neural network 136 could meet the expected result.

The above prediction error is, for example, a mean absolute percentage error (MAPE), a mean-square error (MSE), or a mean absolute deviation (MAD), which is used to calculate the ratio of the prediction sale to the actual sale record. The mean absolute percentage error (MAPE) is a percentage of the absolute value of the sum of the current sale record of the item (saleₜ) minus the inventory volume (stockₜ) and the purchase order (orderₜ₋₁) of the item in the previous sale cycle with respect to the current sale record (saleₜ) of the item. The embodiments are mainly divided into the following three situations: (1) when the sum of the inventory volume (stockₜ) of the item and the purchase order (orderₜ₋₁) of the previous sale cycle is greater than or equal to the sum of the expected sale state (saleₜ₊₁) of the item in the next sale cycle and the standard deviation (stdₜ) of the current sale record, that is, stockₜ+orderₜ₋₁ saleₜ₊₁≥stdₜ, the inventory decision module 140 estimates that the inventory of the item is surplus and needs to be revised downwards for the purchase order 142 of the item in the next sale cycle, to reduce the prediction error; (2) when the sum of the inventory volume (stockₜ) of the item and the purchase order (orderₜ₋₁) of the previous sale cycle is greater than or equal to the expected sale state (saleₜ₊₁) of the item in the next sale cycle, and less than the sum of the expected sale state (saleₜ₊₁) of the item in the next sale cycle and the standard deviation (stdₜ) of the current sale record, that is, saleₜ₊₁+stdₜ≥stockₜ+orderₜ₋₁≥saleₜ₊₁, the inventory decision module 140 estimates that the inventory of the item meets the expected sale state, and there is no need to adjust the purchase order 142 of the item in the next sale cycle; (3) when the expected sale state saleₜ₊₁ of the item in the next sale cycle is greater than the sum of the inventory volume (stockₜ) of the item and the purchase order (orderₜ₋₁) of the previous sale cycle, that is, saleₜ₊₁>stockₜ+orderₜ₋₁, the inventory decision module 140 estimates that the inventory of the item is not enough for the expected sale record, and needs to be revised upwards for the purchase order 142 of a next sale cycle to reduce the prediction error.

The dotted line shown in FIG. 1 indicates that after the inventory decision module 140 adjusts the purchase order 142, the purchase order 142 that conforms to the expected sale state of the item in the next sale cycle is used as the calculation of feedback data 144 of a purchase order of the item in the sale cycle after next for the state analysis module 120 to calculate the reward feedback 122. The reward feedback 122 is, for example, a mean absolute percentage error (MAPEₜ) of the current sale record (saleₜ) of the item, that is, a percentage of the absolute difference between the current sale record (stockₜ) and the prediction sale record (stockₜ+orderₜ₋₁) to the current sale record. The greater the reward feedback 122, the greater the prediction error, and vice versa.

Referring to FIGS. 1 and 2, in step S150, the inventory decision module 140 uses the initial weight 132 of the pre-training model 134 as the weight of the inventory decision module 140 for training, and automatically generates a purchase order 142 that meets the expected sale state of the item in the next sale cycle. If the next prediction is needed, in step S160, the purchase order 142 that meets the expected sale state of the item in the next sale cycle is used as the feedback data 144 for calculating the purchase order of the item in the sale cycle after next, and return to step S130 to predict the sale record of the item in the sale cycle after next, and so on. In addition, in FIG. 1, the purchase order 142 of the next sale cycle could also be stored in the database 126 as training data or test data to increase the data of the pre-training model 134.

Since the automated inventory management system 100 of the embodiment could calculate a reward feedback 122 based on the current sale record 114 and inventory volume 116 of the item and the purchase order 118 of the previous sale cycle through the state analysis module 120, and the reward feedback 122 is input into the pre-trained neural network 136 to predict the sale record of the next sale cycle, so as to avoid relying on the past experience and self-judgment of the personnel to determine the required sale record. The prediction error (i.e., the reward feedback 122) could be reduced, and the probability of full inventory or shortage (i.e., out of stock) could also be reduced, and thus inventory costs are reduced.

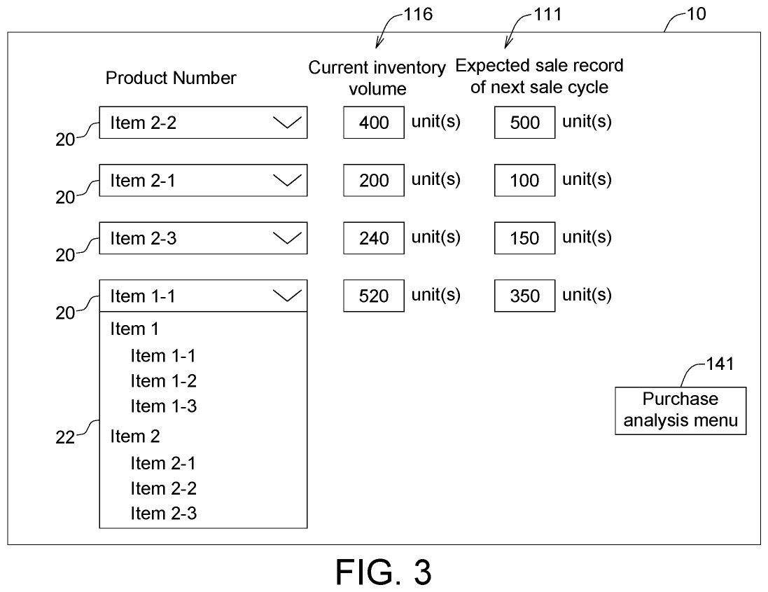

Referring to FIG. 3, which shows a schematic diagram of an automated inventory management interface 10 according to an embodiment of the disclosure. The automated inventory management interface 10 could be displayed on the operating interface of the computer display, and it has a plurality of product fields 20 and a drop-down list 22 for the user to select or manage products of different items. The inventory volume 116 of each item could be automatically generated by the state analysis module 120 according to the current sale record or manually input by the administrator. The expected sale record 111 is, for example, the result of the historical parameter analysis module 110 predicting the sale record of each item in the next sale cycle according to the historical sale state 102.

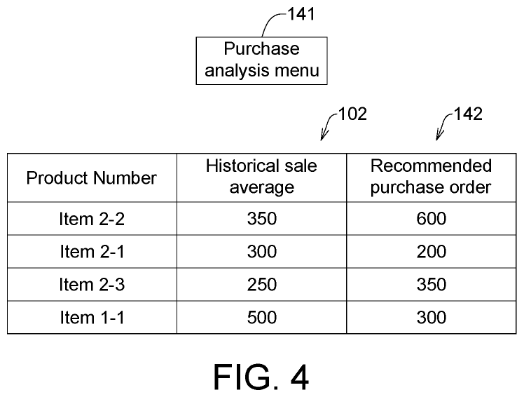

Referring to FIG. 4, which shows a schematic diagram of the purchase analysis of products of different items. The purchase analysis menu 141 is, for example, a pop-up menu, which includes the historical sale state 102 (the average and standard deviation of the historical sale records of 13 weeks) and the inventory decision module 140 automatically generates the recommended purchase order 142 according to the expected sale record 111 and inventory volume 116 in the next sale cycle. Through the aforementioned purchase analysis menu 141, the user could clearly know the purchase order 142 of each item, which saves manual setting of purchase parameters, reduces inventory costs and the risk of misjudgment by personnel.

The following embodiment uses the weekly sale record and historical sale state of items as the test data of the pre-trained neural network 136 for description. Assuming that the current time point t is 2021/1/4 (Monday), the time point t−1 is last week, 2020/12/28 (Monday), and the time point t+1 is next week 2021/1/11 (Monday). at the time point t, the inventory volume (stock₀₁₀₄=100), sale record (sale₀₁₀₄=120), purchase order at the time point t−1 (order₁₂₂₈=150), historical sale average of 13 weeks (mean₀₁₀₄=200). The standard deviation of the historical sale record of 13 weeks (std₀₁₀₄=50), where the expected sale record [symbol] is expressed as the predicted value at the time point t.

First, the sale state (sale₀₁₀₄) of the item is input into the pre-trained neural network 136. The sale state (sale₀₁₀₄) of the item includes the historical sale records from 1 to 52 weeks, and a historical sale average of 13 weeks (mean₀₁₀₄=200), a standard deviation of historical sale record of 13 weeks (std₀₁₀₄=50), expected sale record ( [symbol] ) and expected sale record at the time point t−1 ( [symbol] ), then the pre-trained neural network 136 could output the decision weight (Action₀₁₀₄=0.5), and the inventory decision module 140 calculates the purchase order at the time point t (order₀₁₀₄=mean₀₁₀₄×Action₀₁₀₄=200×0.5=100), output purchase order (order₀₁₀₄=100).

Next, the state analysis module 120 receives the purchase order at time t (order₀₁₀₄=100), the actual sale record at time t (sale₀₁₀₄=120), and the purchase order at time t−1 (order₁₂₂₈=150), and outputs the inventory volume at time t+1 (stock₀₁₁₁=stock₀₁₀₄−sale₀₁₀₄+order₁₂₂₈=100−120+150=130).

At the same time, the state analysis module 120 determines that stock₀₁₀₄, order₁₂₂₈, sale₀₁₀₄, and std₀₁₀₄ belong to the first case (1), because stock₀₁₀₄+order₁₂₂₈≥sale₀₁₀₄+std₀₁₀₄, therefore,

$${MAPE}_{0104} = \frac{\vert {sale}_{0104} - ( {stock}_{0104} + {order}_{1228} ) \vert}{{sale}_{0104}} = 1.0833$$

is obtained. Assuming that the parameter over_penalty=−1, the reward feedback (Reward₀₁₀₄=MAPE₀₁₀₄×over_penalty=1.0833×−1=−1.0833) is output, which means that the inventory of the item is excessive, and the purchase order (order₀₁₁₁) of the item in the next sale cycle needs to be corrected downwards to reduce prediction error.

In another embodiment, if the state analysis module 120 determines that stock₀₁₀₄, order₁₂₂₈, sale₀₁₀₄, and std₀₁₀₄ belong to the third case (3), that is, sale₀₁₀₄>stock₀₁₀₄+order₁₂₂₈, assuming that the parameter under_penalty=−1, the reward feedback (Reward₀₁₀₄=MAPE₀₁₀₄×under_penalty=1.0833×−1=−1.0833) is output, which means that the inventory of the item is Insufficient and the purchase order (order₀₁₁₁) of the next sale cycle needs to be corrected upwards to reduce the prediction error.

Then, at the next time point t+1, the sale state (state₀₁₁₁) of the item is input to the pre-trained neural network 136, and the decision weight (Action₀₁₁₁) is output from the neural network 136, and the inventory decision module 140 calculates the purchase order at the time point t+1 (order₀₁₁₁=mean₀₁₁₁×Action₀₁₁₁), and so on. In this way, the system could automatically generate a purchase order that meets the expected sale record of the item in the next sale cycle.

The aforementioned pre-training model 134 is, for example, a deep neural networks (DNN) model, a convolutional neural network (CNN) model, or a support vector machine (SVM) model for performing machine learning and training. Convolutional neural network models could be divided into regional convolutional neural networks (R-CNN), fast regional convolutional neural networks (Fast R-CNN) and faster regional convolutional neural networks (Faster R-CNN)), etc., by dividing the input information into multiple regions, and dividing each region into the corresponding category, and then combining all the regions together to complete the sale record prediction.

Referring to Table 1, which shows that the prediction results obtained by deep reinforcement learning and pre-training of the neural network 136 in the embodiment are compared with the traditional model based on the historical average sale record of 13 weeks or the sale record prediction of the neural network. It could be seen from Table 1 that the automated inventory management system 100 of the embodiment could reduce the prediction error, in which the mean absolute percentage error (10.54% or lower), the out-of-stock rate (1.48% or lower), and the full inventory rate (3.83% or lower) are better than the prediction results of the traditional model, and then the suitable parameters and neural network 136 are constructed accordingly.

TABLE 1

| | mean absolute | | |
|---|---|---|---|
| | percentage error | out-of-stock | full inventory |
| | (MAPE) | rate | rate |
| historical average | 14.54% | 2.41% | 3.87% |
| sale record of 13 | | | |
| weeks | | | |
| the embodiment | 10.54% | 1.48% | 3.83% |
| of the disclosure | | | |
| traditional neural | 10.55% | 1.84% | 4.35% |
| network | | | |

It could be seen that the automated inventory management method and system of the foregoing embodiments of the disclosure could improve the accuracy of prediction for sale, and reduce inventory costs and the risk of misjudgment by personnel.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. An automated inventory management method, comprising:
receiving a historical sale state, and predicting a future sale of an item based on the historical sale state, so as to obtain a simulation result of an expected sale state of the item in a next sale cycle;
training an initial weight of a pre-training model according to the historical sale state of full categories of items and the simulation result of the expected sale state of the item in the next sale cycle;
using the initial weight of the pre-training model as a weight of an inventory decision module for training, and automatically generating a purchase order that meets the expected sale state of the item in the next sale cycle; and
calculating a reward feedback according to a current sale record and an inventory volume of the item and a purchase order of the item in a previous sale cycle, and inputting the reward feedback and the sale state of the item into the inventory decision module to order the item.

2. The method according to claim 1, further comprises using the purchase order that meets the expected sale state of the item in the next sale cycle as a calculation of feedback data of the purchase order of the item in the sale cycle after next to calculate the reward feedback.

3. The method according to claim 1, further comprising using the reward feedback and the sale state of the item as training data or test data, storing it in a database and input into the pre-training model for pre-training and deep reinforcement learning of a neural network.

4. The method according to claim 1, wherein the historical sale state of full categories of items is the historical sale state of items of different types in same attribute.

5. The method according to claim 4, further comprising providing a transfer model for converting each historical sale state of items of different types in the same attribute into training data, and storing the training data in a training database for training the initial weight of the pre-training model, wherein the reward feedback is used to correct a prediction error of the purchase order of the item in the next sale cycle.

6. The method according to claim 5, wherein the sum of the inventory volume of the item and the purchase order of the previous sale cycle is greater than or equal to the expected sale state of the item in the next sale cycle and the standard deviations of the current sale record, the purchase order of the item in the next sale cycle is revised downward.

7. The method according to claim 5, wherein the sum of the inventory volume of the item and the purchase order of the previous sale cycle is greater than or equal to the expected sale state of the item in the next sale cycle, and less than the sum of the expected sale state of the item in the next sale cycle and the standard deviation of the current sale record, the purchase order of the item in the next sale cycle is not adjusted.

8. The method according to claim 5, wherein the expected sale state of the item in the next sale cycle is greater than the sum of the inventory volume of the item and the purchase order of the previous sale cycle, the purchase order of the item in the next sale cycle is revised upwards.

9. The method according to claim 1, wherein the reward feedback is expressed as a mean absolute percentage error, the mean absolute percentage error is a percentage of the absolute value of the sum of the current sale record of the item minus the inventory volume and the purchase order of the item in the previous sale cycle with respect to the current sale record of the item.

10. The method according to claim 1, wherein the inventory volume of the item and the expected sale state of the next sale cycle are displayed in an automated inventory management interface, and the automated inventory management interface has a product field, a list and a stock analysis menu for users to select or manage products of different items.

11. An automated inventory management system, comprising:
a historical parameter analysis module for receiving a historical sale state and predicting a future sale of an item based on the historical sale state so as to obtain a simulation result of an expected sale state of the item in a next sale cycle;
an initial weight setting module for training an initial weight of a pre-training model based on the historical sale state of full categories of items and the simulation result of the expected sale state of the item in the next sale cycle;
an inventory decision module that uses the initial weight of the pre-training model as a weight of the inventory decision module for training, and automatically generates a purchase order that meets the expected sale state of the item in the next sale cycle; and
a state analysis module that calculates a reward feedback based on a current sale record and an inventory volume of the item and a purchase order in a previous sale cycle, and inputs the reward feedback and the sale state of the item into the inventory decision module to order the item.

12. The system according to claim 11, wherein the inventory decision module further uses the purchase order that meets the expected sale state of the item in the next sale cycle as a calculation of feedback data of the purchase order of the item in the sale cycle after next and input to the state analysis module to calculate the reward feedback.

13. The system according to claim 11, wherein the reward feedback and the sale record of the item are used as training data or test data, stored in a database and input into the pre-training model for pre-training and deep reinforcement learning of a neural network.

14. The system according to claim 11, wherein the historical sale state of full categories of items is the historical sale state of items of different types in same attribute.

15. The system according to claim 14, further comprising a transfer model for converting each historical sale state of items of different types in the same attribute into training data, and storing the training data in a training database for training the initial weight of the pre-training model, wherein the reward feedback is used to correct a prediction error of the purchase order of the item in the next sale cycle.

16. The system according to claim 15, wherein the sum of the inventory volume of the item and the purchase order of the previous sale cycle is greater than or equal to the expected sale state of the item in the next sale cycle and the standard deviation of the current sale record, the purchase order of the item in the next sale cycle is revised downward.

17. The system according to claim 15, the sum of the inventory of the item and the purchase amount of the previous sale cycle is greater than or equal to the expected sale record of the item in the next sale cycle, and less than the item When the expected sale record of the next sale cycle and the sum of the standard deviation of the current sale record, the purchase order of the item in the next sale cycle is not adjusted.

18. The system according to claim 15, wherein when the expected sale record of the item in the next sale cycle is greater than the sum of the inventory of the item and the purchase amount of the previous sale cycle, the item is revised upwards The quantity of this purchase in the next sale cycle.

19. The system according to claim 11, wherein the reward feedback is expressed as a mean absolute percentage error, the mean absolute percentage error is a percentage of the absolute value of the sum of the current sale record of the item minus the inventory volume and the purchase order of the item in the previous sale cycle with respect to the current sale record of the item.

20. The system according to claim 11, wherein the inventory volume of the item and the expected sale state of the next sale cycle are displayed in an automated inventory management interface, and the automated inventory management interface has a product field, a list and a stock analysis menu for users to select or manage products of different items.
